(19) United States
(12) Patent Application Publication
(10) Pub. No.: US 2021/0272104 A1
(43) Pub. Date: Sep. 2, 2021

(54) CloudChain, A permissionedless high speed blockchain platform

(71) Applicants: Rao Dronamraju, The Woodlands, TX (US); Rahul Dronamraju, The Woodlands, TX (US)

(72) Inventors: Rao Dronamraju, The Woodlands, TX (US); Rahul Dronamraju, The Woodlands, TX (US)

(21) Appl. No.: 17/187,777

(22) Filed: Feb. 27, 2021

Related U.S. Application Data
(60) Provisional application No. 62/982,453, filed on Feb. 27, 2020.

(51) Int. Cl. G06Q 20/36; G06Q 20/06; G06Q 20/38

(52) U.S. Cl. CPC G06Q 20/3678; G06Q 20/389; G06Q 20/0658

(57) ABSTRACT

CloudChain is a hybrid blockchain which has the features of both a permissioned and permission less blockchain platforms. CloudChain allows anyone in the world to participate (permission less) as miners just like any permission less public blockchains such as bitcoin and ethereum but at the same time it limits or permits (permissioned) what they can do on the blockchain. The primary objective of CloudChain is to provide full decentralization at the same time solve the problems of permission less blockchains such as security, privacy, performance, and scalability. CloudChain's consensus algorithm is a modified PoA algorithm that consists of two methodologies PoW (Proof of Winning) and PoR (Proof of Running) are the basis for rewarding miners for their participation in mining the blocks of the chain.

### CROSS-REFERENCE TO RELATED APPLICATIONS

This non-provisional patent application references previously filed U.S. provisional patent application No. 62/982,453.

### BACKGROUND

The invention came about while working on Blockchain technologies and realizing that permission less public blockchains have a serious security, privacy, performance and scaling problems as they allow anyone in the world to run a blockchain node and join the network and process transactions as part of the decentralization and mining functionality of public blockchains. At the same time, they also have serious performance issues because of highly compute intensive Proof of Work algorithms resulting in a low TPS (Transactions per Second). In order to solve such problems, we have innovated a permissionedless blockchain technology which is a hybrid between permission less and permissioned blockchains which overcomes these problems.

### BRIEF SUMMARY OF THE INVENTION

This invention is a blockchain invention. The CloudChain is a hybrid blockchain having the characteristics of both a permission less blockchain and a permissioned blockchain. That is why we are calling it a permissionedless blockchain. It is decentralized just like any public permission less blockchain but at the same time it limits or permits what a miner can do on the blockchain just like a permissioned blockchain. In order to achieve this invention, the solution lets miners join CloudChain and pick compute entities run on their behalf by the blockchain. Anyone from the world can join the blockchain as a miner and select compute entities to be run on their behalf for a certain number of time slots called epochs. In addition to the permissionedless methodology of decentralization and running miner compute entities it also has an innovative consensus algorithm which is based on two methods, Proof of Winning and Proof of Running, which selects the lead miner of the blockchain for signing the block and propagating it to the blockchain network. CloudChain's innovations solve the problems of security, privacy, performance and scalability inherent with public blockchains.

### BRIEF DESCRIPTION OF THE DRAWINGS

Various techniques will be described with reference to the drawings, in which:

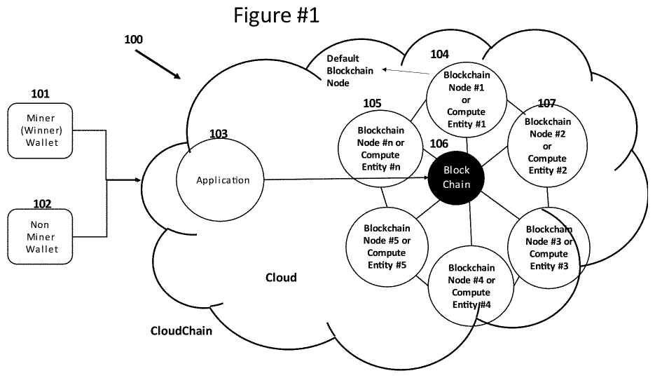

1. FIG. 1: Shows the illustrative example of an environment in which various embodiments may be practiced.

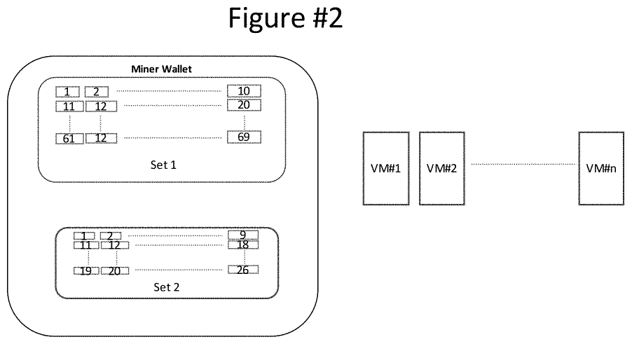

2. FIG. 2: Shows an illustrative example of the miner wallet with the Proof of

Winning (PoW) numbers selection panel and Compute Entity selection panel for Proof Running (PoR)

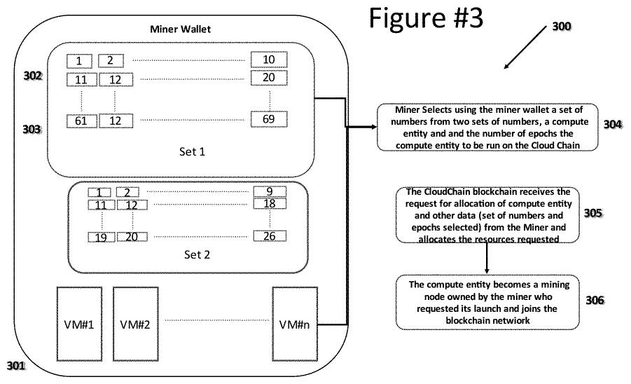

3. FIG. 3: Shows an illustrative example of how a miner using a miner wallet selects a set of numbers form two sets of numbers for PoW and Compute Entity selection for PoR.

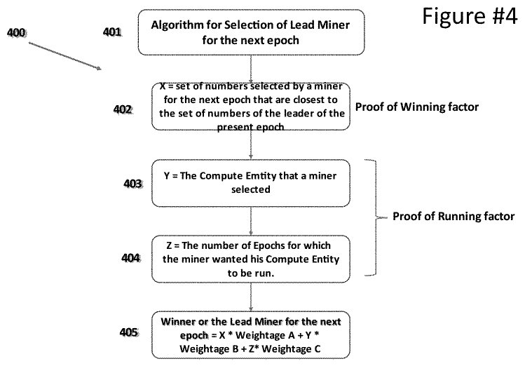

4. FIG. 4: Shows an illustrative process of selecting the lead miner for the next epoch by the present lead miner based on the PoW and PoR algorithms.

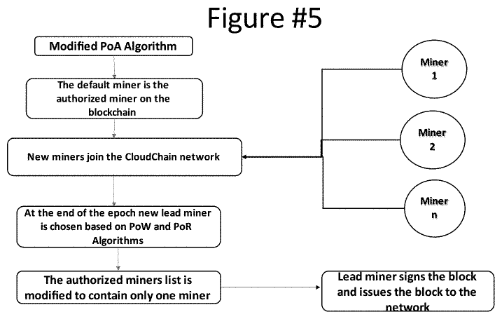

5. FIG. 5: Shows an illustrative process of how the modified PoA algorithm works.

### DETAILED DESCRIPTION OF THE DRAWINGS

FIG. 1 illustrates an environment in which various embodiments can be implemented. The computing environment 100 illustrates two types of clients of the CloudChain blockchain network, a mining client 101 and a non-mining client 102. The mining client 101 uses a miner wallet to select a set of number from two sets of numbers as part of PoW (Proof of Winning) methodology and also a compute entity to be run on his behalf on the CloudChain for certain number of epochs. The application server 103 receives the request from the mining client 101 for allocation of compute resources on its behalf as selected in the mining wallet. The application server 103 launches a compute entity 107 on the CloudChain blockchain 106. The client 102 is a non-mining client that issues only transactions to the CloudChain 106. The mining client 101 can, in addition to selecting a set of numbers from two sets of numbers from the miner wallet and select a compute entity to be launched on its behalf by the CloudChain for a certain number of epochs, issue transaction to the CloudChain network. The mining wallet 101 and non-mining wallet may be implemented using software, hardware or a combination of both and may be connected to the CloudChain 106 blockchain via any computer network including the internet, intranet or a cellular network, a local area network, a satellite network or any other such network and/or a combination thereof.
The compute entities 107, 104 allocated and launched on the CloudChain 106 blockchain in behalf of the mining clients run for certain number of time slots called epochs. The epochs during which the compute entities to be run on the CloudChain 106 on behalf of mining clients are chosen by the mining clients from the mining wallets 101.
FIG. 2 illustrates an environment of the miner wallet from which a miner selects a set of numbers from n other set of numbers and a compute entity to be run for a certain number of epochs on the miner's behalf by the CloudChain blockchain. The set of picked numbers are inputs to the Proof of Winning algorithm and the selected compute entity and the number of epochs are inputs to the Proof of Running Algorithm
FIG. 3 illustrates a miner wallet using which a miner selects a set of numbers from two sets of numbers. In addition to selecting the numbers, the miner also selects a compute entity to be run on the CloudChain blockchain on his behalf by the cloud. The two sets of numbers depicted in the FIG. 2 are not fixed. They are dynamically configurable. The compute entities are also not fixed and are dynamically configurable based on the type and size of the compute entities made available by a cloud on which the CloudChain runs.
FIG. 4 shows an illustrative example of the algorithm for the selection of the lead miner for the next epoch. The lead miner for the present epoch receives the PoW and PoR parameters selected by a miner from the miner wallet.
The set of numbers selected by a miner from the miner wallet depicted in the diagram as X are the parameters to the Proof of Winning part of the modified PoA (Proof of Authority) consensus algorithm used for selecting the lead miner for the next epoch. The Compute Entity and the number of Epochs for which the compute entity to be run on behalf of the miner by the CloudChain depicted in the diagram as Y & Z are parameters to the Proof of Running part of the modified PoA algorithm.
The lead miner for the next epoch is decided by the formula X * Weightage for PoW+Y*Weightage for PoR Compute Entity+Z*Weightage for Number of Epochs
FIG. 5 shows an illustrative example of the modified PoA algorithm. As miners join the CloudChain blockchain network they are added to the PoA list. At the end of each epoch, the PoA list is modified to contain only the lead miner for the next epoch which will sign the block and propagate it to the network.

### DETAILED DESCRIPTION OF THE INVENTION

This section describes in detail the workings of CloudChain which is a hybrid blockchain that has some characteristics of a permission less blockchains and permissioned blockchains. That is why CloudChain is called a Permissionedless Blockchain deriving its name from both permissioned and permission less methods of public and private blockchains. In this detailed description we first define some fundamental concepts of this innovation and describe the detailed workings based on the defined concepts. Permissionedless—A permissionedless blockchain is a hybrid blockchain that has some characteristics of permission less public blockchains and permissioned private or consortium blockchains. A permissionedless blockchain allows anyone from the world to join the network just like any permission less public blockchain to issue transactions or be a miner but limits or permits what they can do on the blockchain and where they can run their blockchain nodes (on the cloud). Cloud Sourcing—Cloud Sourcing is the method of sourcing resources needed for running the blockchain such as compute entities, storage entities and network entities are sourced from the miners of the blockchain and allocated on the clouds. Miners join the CloudChain network and chose what kind of resources they would like to be run on their behalf on the CloudChain network. The miners pay for the resources and reap mining rewards when they become winners based on PoW and PoR algorithms. Modified Proof of Authority (PoA)—In the modified PoA method of choosing the authorized miners to sign the blocks, a lead miner is chosen every epoch based on PoW and PoR algorithms. The lead miner signs the block and propagates to the network. Lead Miner—Miners earn their mining rewards by becoming leaders of a consensus process. The Consensus process is an algorithm and method based on PoW (Proof of Winning) and PoR (Proof of Running) algorithms. Epoch is the time duration during which a lead miner is selected to sign and propagate blocks to the network. POW or Proof of Winning is a method or algorithm that contributes to the selection of a leader miner along with PoR or Proof of Running method. In PoW, miners select N numbers from two sets of numbers just like in lotteries such as Powerball or mega millions. At the end of an epoch period lead miner is selected among all participating miners in the blockchain network based on the numbers picked by a miner which is closest to the numbers picked by the lead miner of the present epoch period. The numbers closest to the lead miner's numbers are called winning numbers. The lead miner for the next epoch time/duration is selected based on a formula into which PoW is a major factor. PoR or Proof of Running is a method that contributes to the selection of lead miner for the next epoch time along with PoW. Proof of Running is derived from the size of the cloud compute entity resource that is chosen to run in the blockchain network by a miner who joins the network to mine on the CloudChain and duration for which the miners runs the resource to process blockchain transactions. PoR along with PoW are the two major factors that decide the next lead miner of the next epoch. PoR encourages miners to pick bigger/larger compute instances for longest duration which will contribute towards more transactions processed per unit time or TPS. By making the leader selection algorithm a function of both PoR and PoW we reward miners for contributing to the transaction processing of the network at the same time PoW makes sure that miner with the largest computer entity does not monopolize the reward money and thereby mitigating reward centralization or reward monopolization. Allocation of Mining Nodes Mining nodes are allocated on the CloudChain on behalf of a miner. Miners when they join the CloudChain blockchain, select resources to be run on their behalf on the cloud. These selected compute, storage and network resources are allocated and run on behalf of the miners on the CloudChain blockchain. Selection of Mining Node Size and Duration Mining node size and the duration for which the node to be run on the cloud is chosen by a miner from the mining wallet.

This document describes how the CloudChain works based on the major technical concepts and definitions described above.

CloudChain is a permissionedless blockchain. A permissionedless blockchain is a hybrid blockchain which has some characteristics from private permissioned blockchains and public permission less blockchains.

In the CloudChain, participants from all over the world are allowed to join the network as miners just like in a permission less blockchains of public blockchains such as bitcoin or Ethereum blockchain. After joining the CloudChain, the miners run their compute entities or mining machines on a cloud. They do this by selecting a compute entity and associated resources from the Miner Wallet. The resources selected are the resources supported by the Cloud Service Provider. After selecting the resources miners ask the CloudChain to launch and run the selected resource on their behalf for a specified time called epoch or a number of specified epochs. Miners pay the CloudChain for running these resources on their behalf on the cloud using the Miner Wallet. These resource contributions by a miner for certain amount of time or epoch or certain number of time slots or epochs are considered as inputs to the PoR (Proof of Running) consensus algorithm. The PoR consensus algorithm in conjunction with the PoW algorithm decides on who would be the lead miner for the epoch and earn mining rewards. The more the PoR contributions of a miner, better his/her chances of being the lead miner for the epoch and earn mining rewards.

In addition to choosing the compute entities to be run for certain epoch or epochs, miners also chose a set of numbers from two sets of numbers. These numbers are randomly chosen from two sets of numbers and are used by the CloudChain consensus algorithm as part of its PoW (Proof of Winning) consensus algorithm. The idea behind the PoW algorithm is to introduce some random luck into the formula of choosing the lead miner for the epoch who will sign and propagate the transaction blocks and earn the mining rewards for that epoch. The random luck factor in the formula mitigates monopolization of mining reward money by miners who chose the largest compute entities for longest time or most number of epochs towards PoR contribution.

What is claimed is:

1. A Blockchain Solution implemented on a Network of Computers, comprising:
Permissionedless method of allowing the participants on the network. Permissionedless method is a hybrid method that comprises of permissioned and permission less methods of allowing the participants on the blockchain network. Blockchain miners and non-mining participants from anywhere in the world can join the CloudChain network (permissionless) but what operations they can perform on the CloudChain is controlled and permitted (permissioned).
Miners and non-miners join the CloudChain network by registering themselves with the CloudChain network. Anyone from the world can join the network making it a permission less network. Non-Mining Clients issue transactions and pay for the transactions using the non-Mining Wallets. Mining Clients issue transactions on the CloudChain network using Mining Wallets and also do mining by launching compute and other resources needed on the CloudChain.
Mining Clients issue transactions and chose Compute Entities & resources that they want to run on the CloudChain using the Mining Wallets. The Compute Entities are of different compute capacities such as the size of a virtual machine in terms of its CPU, Memory, and other resources. The Mining Client also choses the Compute Entity to be run for a certain number of time slots called EPOCHs. The CloudChain network runs the compute entities for certain duration or number of EPOCHs as chosen by the miner from his/her wallet.
In addition to choosing the size of the computer entity and duration for which to run the compute entity, the miner also choses a set of numbers from two groups of numbers.
These numbers and the compute entity size, duration of run (epoch or epochs) are used in the PoW and PoR Algorithms. PoW is the Proof of Winning Algorithm. PoW is a method by which the numbers chosen by a miner are used to determine the winner of mining reward for that epoch. PoR is the Proof of Running method which quantifies the contributions of a miner towards the transaction processing capability of the CloudChain network.
PoW and PoR are used to determine the mining reward of a miner for that epoch. The numbers chosen by a miner from his/her wallet are used to determine the leader miner for the next epoch. Only the leader miner or miners can issue blocks to the network. Only the leader miner or miners can earn mining rewards for that epoch.
A percentage of the transaction processing fees collected from various transaction issuing clients of the CloudChain network is used as leader miner rewards at the end of epoch.
When a miner choses a compute entity or compute resources he/she also pays for running it on the CloudChain for an epoch or multiple epochs.

2. The computer implemented method of independent claim 1, wherein Mining Clients of the Blockchain can participate in the mining operations by choosing a compute entity and resources to be run on their behalf.

3. The computer implemented method of independent claim 1, wherein Mining Clients of the Blockchain can participate in the mining operations by choosing a set of numbers from two sets of numbers.

4. The computer implemented method of independent claim 1, wherein Mining Clients of the Blockchain can participate in the mining operations by choosing the time (epoch) for which the chosen compute entity or compute resources to be run and the number of epochs to run the chosen compute entities & resources.

5. The computer implemented method of independent claim 1, wherein Mining Clients pay for the compute entity or compute resources and the epochs for which their compute entities are run on the blockchain network.

6. The computer implemented method of independent claim 1, wherein compute entities and resources are allocated, launched and run on-behalf of each mining client based on their selections from the Mining Client wallet.

7. The computer implemented method of independent claim 1, wherein a mining client is a client of modified PoA (Proof of Authority) consensus mechanism when initiated into the blockchain network.

8. The computer implemented method of independent claim 1, wherein a lead miner for the next epoch is made the only authorized client of modified PoA after being selected through the PoW (Proof Winning) and PoR (Proof of Running) consensus algorithm.

9. The computer implemented method of independent claim 1, wherein the method of crowd sourcing the cloud resources for mining.

10. The computer implemented method of independent claim 1, wherein the method of mining rewards are distributed to the lead miner for that epoch and to the cloud chain.

11. A modified POA consensus algorithm, comprising:
A lead miner which is the only mining client that is allowed to sign a block and propagate the block.
A PoW (Proof of Winning) method of choosing among the Mining Clients the lead miner for block signing and propagation in the next epoch and for earning of mining rewards for that epoch. A PoR (Proof of Running) method of choosing among the Mining Clients the lead miner for block signing and propagation in the next epoch and for earning mining rewards for that epoch.
The reward winning miner is decided by the formula as below.
Lead Miner for the next epoch=longest duration or number of epochs for which the compute entity is run multiplied by weightage factor X+size of the compute entity multiplied by weightage factor Y+nearest random numbers selected multiplied by weightage factor Z. X, Y and Z are configurable values.
Dependent Claims

12. The PoW method of independent claim 11, wherein a mining client choses n random numbers from a set of m numbers and p random number from a set of q numbers.

13. The PoR method of independent claim 11, wherein a mining client choses a compute entity of a certain size as provided by the cloud.

14. The PoR method of independent claim 11, wherein a mining client choses the time slot or epoch for which a compute entity to be run.

15. The PoR method of independent claim 11, wherein a mining entity choses the number of time slots or epochs for which the compute entity to be run.

16. The lead miner for the next epoch selection method of independent claim 11, where in is based on the formula Lead Miner for the Next Epoch=LongestDurationValuelist multiplied by A% (percentage weightage which is a dynamically configurable value)+RandomNearestList multiplied by B% (percentage of weightage which is a dynamically configurable value)+ConfigurationList multiplied by C% (percentage of weightage which is a dynamically configurable value).

17. The modified PoA (Proof of Authority) of independent claim 11 where in the list of authorized miners is changed to allow for one lead miner to be the authorized miner to sign and issue blocks for the next epoch based on PoW and PoR algorithms.

18. The mining reward methodology wherein by making the leader selection algorithm a function of both PoR and PoW we reward miners for contributing to the transaction processing of the network at the same time PoW makes sure that miner with the largest computer entity does not monopolize the reward money and thereby mitigating reward centralization or reward monopolization.
Dependent Claims

19. The leader selection methodology of independent claim 18, where in the miner with the largest compute resources for the longest duration and best matching PoW numbers with the numbers of lead miner of the present epoch as the selection criteria for the lead miner for the next epoch.
